(19) United States
(12) Patent Application Publication
(10) Pub. No.: US 2018/0326360 A1
(43) Pub. Date: Nov. 15, 2018

(54) A POLYVINYL ALCOHOL POROUS SUPPORT AND METHOD

(71) Applicant: BL Technologies , Inc., Minnetonka, MN (US)

(72) Inventors: Li May GOH, Singapore (SG); Lawrence C. COSTA, Mansfield, MA (US); Kai ZHANG, Singapore (SG); Dezhong XIAO, Singapore (SG); Kia Kian KEE, Singapore (SG); Kin Ho WEE, Singapore (SG); Ranting WU, Singapore (SG)

(21) Appl. No.: 15/775,670

(22) PCT Filed: Nov. 20, 2015
(86) PCT No.: PCT/US2015/061925

§ 371 Date: May 11, 2018

(51) Int. Cl. B01D 67/00; B01D 69/12; C02F 1/44

(52) U.S. Cl. CPC B01D 67/0006; B01D 67/0011; B01D 71/38; B01D 69/125; C02F 1/441; B01D 67/0016

(57) ABSTRACT

Disclosed here are semi-permeable cross-linked polyvinyl alcohol (PVA) based membranes that can be used as supports for water purification membranes, and methods for their production. The cross-linked PVA-based membranes are cross-linked with the reaction product of poly-epoxides and —OH groups from the PVA polymers. Methods according to the present disclosure include crosslinking dissolved PVA and dissolved poly-epoxides, casting the cross-linked PVA, and coagulating the cast polymer in a phase immersion precipitation process.

### FIELD

The present disclosure relates to polyvinyl alcohol porous supports used to make membranes for water purification, and methods of their production.

### BACKGROUND

The following paragraphs are not an admission that anything discussed in them is prior art or part of the knowledge of persons skilled in the art.

Membranes for water purification, for example reverse osmosis membranes, use a semipermeable membrane to separate impurities from the water by selectively allowing water molecules to pass through the membrane. In reverse osmosis, sufficient pressure difference is applied across the membrane to overcome the osmotic pressure associated with the water being purified. This results in the solute being retained on the high pressure side of the membrane and the purified solvent passing through the membrane to the purified side.

### INTRODUCTION

The following introduction is intended to introduce the reader to this specification but not to define any invention. One or more inventions may reside in a combination or sub-combination of the elements or method steps described below or in other parts of this document. The inventors do not waive or disclaim their rights to any invention or inventions disclosed in this specification merely by not describing such other invention or inventions in the claims.

Membranes used for water purification may be subjected to high pressures. In such purification processes, it is desirable to use a semi-permeable membrane that is strong enough to resist the pressure being applied to the membrane. Although polysulfone-based reverse osmosis membranes are capable of resisting the pressures applied during reverse osmosis, the production of polysulfone-based membranes requires the use of hazardous solvents, such as dimethylformamide (DMF). The use of such hazardous solvents is environmentally undesirable and increases the cost of production of the polysulfone-based membranes.

Therefore, there remains a need for alternative semi-permeable membranes that can be used as a support for water purification membranes, and for methods for their production. The present disclosure provides a polyvinyl alcohol (PVA) based membrane as such an alternative membrane, and provides a method for producing the PVA-based membrane that reduces the amount of hazardous solvents needed for their production.

In one aspect, the present disclosure provides PVA-based membranes where the polyvinyl alcohol groups are cross-linked by a poly-epoxide based compound. Exemplary poly-epoxide based cross-linkers include diglycidyl ethers. In one specific example, the PVA-based membrane is crosslinked with cyclohexanedimethanol diglycidyl ether (CHDMDGE, Sigma-Aldrich SKU 338028).

PVA-based membranes according to the present disclosure may have a molecular weight cutoff for sugar of about 500 g/mol to about 10,000 g/mol. For clarity, “molecular weight cutoff” means that the membranes have a pore size that prevents sugar (such as dextran, sucrose or lactose) that is larger than the noted molecular weight from passing through the membrane. In preferred examples, the molecular weight cutoff of the membrane is from about 2000 g/mol to about 4,000 g/mol of sugar.

PVA-based membranes according to the present disclosure, such as PVA-based membranes that are cross-linked with CHDMDGE, may have physical characteristics that make them suitable for use as supports for reverse osmosis membranes, such as sufficient strength to withstand pressures applied during reverse osmosis.

In some particular examples of reverse osmosis membranes, the PVA-based membranes are covalently bonded to a salt-rejecting polymer layer, such as through ester bonds between the PVA alcohols and carbonyl groups in the salt-rejecting polymer. Reverse osmosis membranes with covalent bonds between the PVA support layer and the salt-rejecting polymer layer have increased resistance to delamination in comparison to membranes where the support layer interacts with the salt-rejecting polymer layer through dipole-dipole interactions (also known as van der Waals interactions).

The salt-rejecting polymer layer may be formed on the PVA-based membrane through interfacial polymerization that forms covalent bonds between the support and the salt-rejecting polymer layer. The interfacial polymerization may be carried out using trimesoyl chloride (TMC, or 1,3,5-benzenetricarbonyl trichloride) and m-phenylenediamine (MPD), resulting in a salt-rejecting polyamide layer.

Interfacial polymerization using TMC and MPD may be achieved by reacting TMC with the PVA-based membrane, thereby forming covalent bonds through the reaction of the hydroxyl groups on the PVA with the acid chlorides of the TMC. Unreacted acid chlorides are then reacted with amine groups from the MPD, forming the salt-rejecting polyamide layer. Additional TMC may be added to the resulting polyamide layer to react with free amine groups.

In another aspect, the present disclosure provides a method of making a PVA-based membrane that is cross-linked by a poly-epoxide based compound. The method includes crosslinking a dissolved PVA and a dissolved poly-epoxide, casting the dissolved polymer, and then coagulating the resulting cross-linked polymer using a liquid in which the dissolved polymer is substantially insoluble.

The cross-linker is preferably water soluble so that both the PVA and the cross-linker may be dissolved in an aqueous solvent for the cross-linking step, thereby reducing or avoiding the use of hazardous solvents, such as DMF.

The method described herein generates a cross-linked PVA membrane with homogeneous crosslinking in the membrane since the PVA and the cross-linker are both dissolved in the solvent before the membrane is formed in the coagulation step. Coagulating the PVA first and then crosslinking the coagulated PVA would form surface bonds, and would result in heterogeneous crosslinking in the membrane.

Silica may be included in the formation of the cross-linked PVA membrane. Silica that is incorporated into a membrane may be removed by treatment with sodium hydroxide, thereby forming pores in the membrane. Methods disclosed herein do not require silica to be included in the formation of the cross-linked membrane since the combination of phase separation and mass transfer in the coagulation step affects the membrane structure, such as the pore size. The phase separation and mass transfer may be affected by changing the speed of the membrane coated with PVA passing through the coagulation tank containing saturated salt solution, the temperature of the coagulation tank, the temperature of the PVA solution, the composition of the PVA solution, the composition of the coagulation solution, or a combination thereof.

Avoiding using silica in the process results in a process that reduces, or substantially eliminates, the amount of caustic sodium hydroxide used to produce the membrane. This is desirable from an environmental and cost perspective.

### BRIEF DESCRIPTION OF THE DRAWINGS

Embodiments of the present disclosure will now be described, by way of example only, with reference to the attached Figures.

FIG. 1 is a flow chart illustrating an exemplary method according to the present disclosure;

FIG. 2 is a photograph of a cross-linked PVA membrane made using a method according to the present disclosure;

FIG. 3 is a photograph of another cross-linked PVA membrane made using a method according to the present disclosure;

FIG. 4 is a photograph of a comparative example of a cross-linked PVA membrane made using a method other than a disclosed method; and

FIG. 5 is a photograph of a comparative example of a cross-linked PVA membrane made using another method other than a disclosed method.

### DETAILED DESCRIPTION

Definitions. The singular forms “a”, “an”, and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

Throughout the disclosure, the term “hydrocarbon” represents hydrocarbon groups, preferably containing from 1-20 carbon atoms. In the context of the disclosure, it would be understood that reference to a “hydrocarbon” refers to a hydrocarbon radical that is chemically bonded to the compound of reference. Hydrocarbons according to the present disclosure may further comprise one or more heteroatoms, such as oxygen, nitrogen, and sulfur. The hydrocarbon may be, for example, an alkyl, a cycloalkyl, or an aromatic hydrocarbon.

“Alkyl” groups refer to straight or branched hydrocarbons having the general structure CₙH₂ₙ₊₁, where “n” is preferably from 1 to 6. Examples of alkyl groups include methyl, ethyl, n-propyl, isopropyl, n-butyl, tert-butyl, isooctyl, benzyl, cyclohexylmethyl, phenethyl, alpha,alpha-dimethylbenzyl, and the like.

“Acyl” groups refer to functional groups of the general formula —C(═O)—R¹, where R¹ is a hydrocarbon. For example, an acyl group may be: —C(O)CH₃, or —C(O)CH₂CH₃. When bonded to an R—OH group, the acyl group forms an ester: R—OC(O)R¹. When bonded to an amine group, the acyl group forms an amide: R—NH—C(O)R¹.

The term “polyvinyl alcohol” (PVA) is a polymer having the general structure [CH₂CH(OR)]ₙ where R is independently H, acyl or alkyl. In the context of the present disclosure, PVA preferably includes polyvinyl alcohol polymers: having a degree of hydrolysis from about 50% to 100%; and having a molecular weight from about 85,000 g/mol to about 186,000 g/mol when at 99% hydrolysis. The term “degree of hydrolysis” refers to the percent of the —OR groups in the PVA that are —OH groups. A PVA-based polymer that is 100% hydrolyzed refers to a PVA-based polymer where all of the —R groups are —OH. It is desirable for the PVA to have a degree of hydrolysis of at least 50% since hydrolyzed side groups increase the ability for the PVA to dissolve in water. It is desirable for the molecular weight of the PVA to be from about 85,000 g/mol to about 186,000 g/mol when at 99% hydrolysis since the molecular weight of the PVA affects the viscosity of the dissolved PVA, which in turn affects the pore size and the resulting flux of the final coated PVA membrane.

Discussion. Generally, the present disclosure provides a PVA-based polymer membrane, a water purification membrane that includes a PVA-based polymer membrane, a method of making the PVA-based polymer membrane, and a method of making the water purification membrane.

The present disclosure provides PVA-based membranes where the polyvinyl alcohol groups are cross-linked by a poly-epoxide based compound. Such PVA-based membranes may be referred to as “cross-linked PVA membranes”.

Poly-epoxide based cross-linkers that may be used to cross-link the PVA have more than one epoxide group capable of reacting with the PVA-based hydroxyl groups. Contemplated poly-epoxide based cross-linkers include, for example, two or three epoxide groups.

Examples of poly-epoxide based cross-linkers with two epoxide groups that could be used according to the present disclosure include diglycidyl ethers and dialkylene diepoxides. Examples of diglycidyl ethers include: diglycidyl ether; ethylene glycol diglycidyl ether; 1,4-butanediol diglycidyl ether; resorcinol diglycidyl ether; neopentyl glycol diglycidyl ether; propylene glycol diglycidyl ether; glycerol diglycidyl ether; and cyclohexanedimethanol diglycidyl ether (CHDMDGE). Dialkylene diepoxides are epoxides formed from compounds having two double bonds. Examples of dialkylene diepoxides include: butadiene diepoxide; 1,5-hexadiene diepoxide; 1,2,7,8-diepoxyoctane; and 4-vinylcyclohexene diepoxide.

Examples of poly-epoxide based cross-linkers with three epoxide groups that could be used according to the present disclosure include epoxides formed from compounds having three double bonds, referred to herein as trialkylene triepoxides. Specific examples of trialkylene triepoxides include: trimethylolpropane triglycidyl ether; tris(2,3-epoxypropyl)isocyanurate; tris(4-hydroxyphenyl)methane triglycidyl ether; and N,N-diglycidyl-4-glycidyloxyaniline.

The cross-linked PVA membranes according to the present disclosure may have a thickness of about 2 mils to about 20 mils. A “mil” refers to a thousandth of an inch. In particular examples, the cross-linked PVA membranes have a thickness of about 11 mils.

The cross-linked PVA membranes according to the present disclosure may have a cross-linker density of about 30:1 to about 75:1 (moles of PVA:mole of cross-linker).

In preferred examples, the cross-linker density is from about 45:1 to about 55:1 as this density provides a membrane with desirable physical properties. The physical properties of a membrane are affected by the cross-linker density since crosslinking affects the strength, flexibility, flux, and/or salt rejection of the membrane. It should be noted that desirable characteristics of the membrane are not simply achieved by increasing the cross-linker density. Rather, changing the cross-linker density may result in making one physical property better while making a different physical characteristic worse.

An illustration of an exemplary crosslinking between two PVA polymers is shown below. The PVA polymers are bound to the cross-linker though ether bonds, where those ether bonds are the reaction products between —OH groups on the PVA polymers and epoxide groups on CHDMDGE.

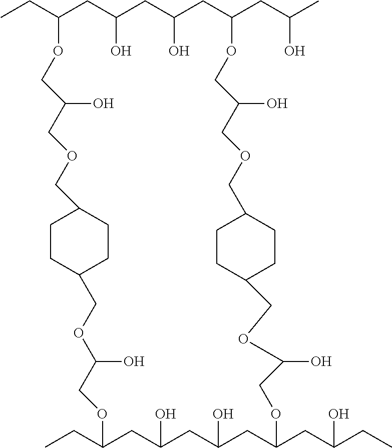 [SMILES: CCC(O)CC1CC(O)CC(O)CC(CC)OCC(O)OCC2CCC(CC2)COCC(O)COC(CC)CC(O)CC(O)CC(CC(C)O)OCC(O)COCC2CCC(CC2)COC(O)CO1]

The cross-linked PVA membrane may be used as the membrane support for a water purification membrane, such as a reverse osmosis (RO) membrane. The salt-rejecting layer of the RO membrane may be formed on the cross-linked PVA membrane, preferably using covalent bonds to join the salt-rejecting layer to the cross-linked PVA membrane. However, although there are benefits associated with covalently bonding the salt-rejecting layer to the cross-linked PVA membrane, the present disclosure contemplates salt-rejected layers that are not covalently bonded to the cross-linked PVA membrane.

One example of a salt-rejecting layer covalently bonded to the cross-linked PVA-based membrane is a polymer layer formed on the cross-linked PVA-based membrane through interfacial polymerization using trimesoyl chloride (TMC, or 1,3,5-benzenetricarbonyl trichloride) and m-phenylenediamine (MPD). Other examples of a salt-rejecting layer may be formed using succinyl chloride or malonyl chloride (see Alsvik, I L, et al. “Polyamide formation on a cellulose triacetate support for osmotic membranes: Effect of linking molecules on membrane performance”, Desalination, 312 (2013) pp 2-9.). Still other examples of a salt-rejecting layer may be formed using p-phenylenediamine (PPD), 2,6-diaminetoluene, 1,4-diaminocyclohexane, or methylated MPD (see Alsvik, I L and Hagg, M B. “Pressure Retarded Osmosis and Forward Osmosis Membranes: Materials and Methods”, Polymers 5 (2013), pp 303-327). Still other examples maybe formed using combinations of the noted acid chlorides and noted polyamines.

An interfacial polymerization layer formed using TMC and MPD may be produced by first reacting TMC with the PVA-based membrane, thereby forming covalent bonds through the reaction of the hydroxyl groups on the PVA with the acid chlorides of the TMC. Unreacted acid chlorides are then reacted with amine groups from the MPD, forming the salt-rejecting polyamide layer. Additional TMC may then be added to the resulting polyamide layer to react with free amine groups. Unreacted acid chloride groups from the TMC will react with water during a conditioning step of the membrane to generate carboxylic acid groups.

An illustration of a portion of an exemplary salt-rejecting layer covalently bonded to —OH groups from a cross-linked PVA-based membrane according to the present disclosure is shown below. The acyl chloride groups have been transformed into —COOH groups through hydrolysis.

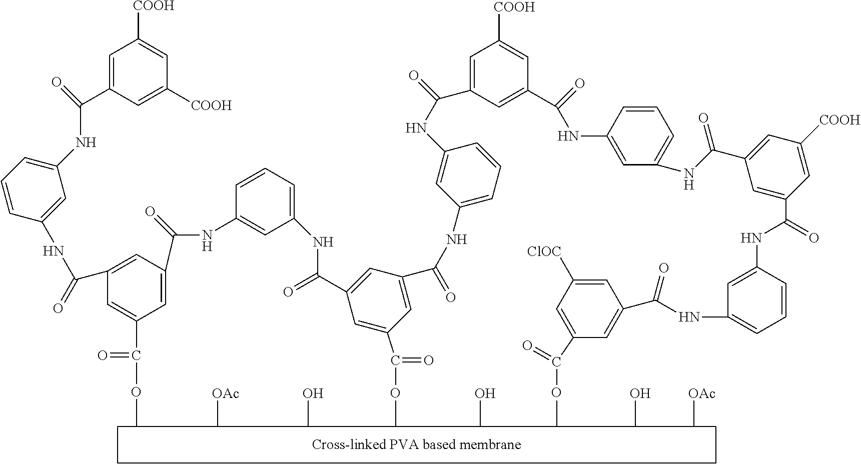

The extent of esterification between PVA and TMC can be affected by adjusting the concentration of TMC, and the polarity of the solvent used to dissolve the TMC. The extent of esterification should be selected such that the resultant TMC-PVA membrane is strong and resistant to delamination; and such that the TMC on the membrane retains a sufficient amount of carbonyl chlorides to further react with the MPD. The TMC may be dissolved in a polar aprotic solvent, preferably diethylene glycol diethylether, for application to the cross-linked PVA membrane.

The density of the interfacial layer can be varied by changing the concentration of the MPD and TMC. Changing the density of the interfacial layer may affect the flux and salt rejection, but may not significantly affect the thickness of the membrane. In preferred examples, the concentration of MPD is between about 1.0 wt % and about 5 wt %. In preferred examples, the concentration of TMC is between about 0.05 wt % and about 0.5 wt %. These concentrations are preferred since they result in a membrane with a flux and salt rejection profile that is suitable for water purification.

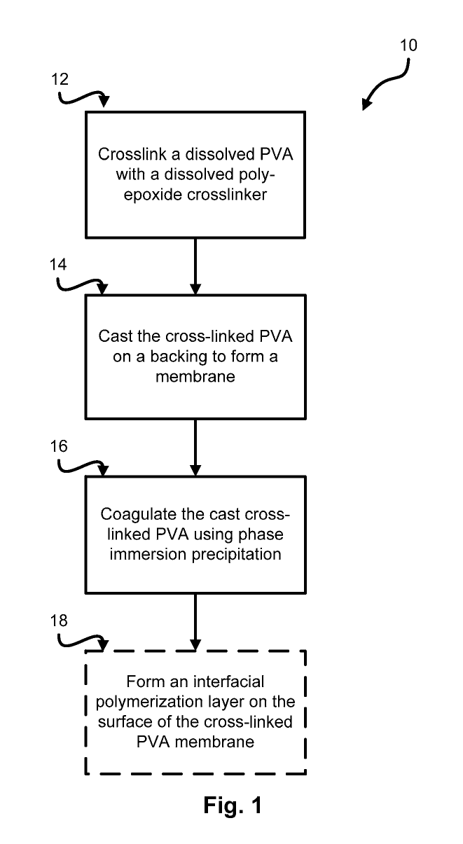

FIG. 1 is a flow chart illustrating an exemplary method (10) according to the present disclosure. Exemplary methods according to the present disclosure include crosslinking (12) a dissolved PVA and a dissolved poly-epoxide, casting (14) the dissolved polymer on a backing, and then coagulating (16) the resulting cross-linked polymer using phase immersion precipitation. The method may optionally include forming (18) an interfacial polymerization layer on the surface of the cross-linked PVA membrane.

It was surprisingly found that curing a cross-linked PVA polymer, for example at an elevated temperature, without coagulation, resulted in a membrane with at least one undesirable characteristic. In some methods, curing a cross-linked PVA polymer without coagulation resulted in a membrane that was rough, spalled, and penetrated the polyester backing. Some exemplary cross-linked PVA polymers made using methods according to the present disclosure are smooth, do not spall, and do not penetrate the backing.

The poly-epoxide cross-linker is preferably water soluble so that the poly-epoxide cross-linker and the PVA can be dissolved in an aqueous solution. Using an aqueous solution reduces or avoids the use of hazardous solvents, such as DMF. The poly-epoxide cross-linker and the PVA may be, for example, dissolved in distilled water.

The poly-epoxide cross-linker is preferably dissolved at a concentration from about 0.1% to about 20% wt/wt, and preferably from about 4% to about 8% wt/wt, based on the total weight of the reagent and the solvent. The PVA is preferably dissolved at a concentration from about 0.1% to about 50% wt/wt, and preferably from about 5% to about 10%, based on the total weight of the reagent and the solvent. For clarity, 20 g of PVA dissolved in 380 g water corresponds to a 5% PVA solution; and 2 g CNDMDGE dissolved in 48 g of the 5% PVA solution corresponds to a 4% CHDMDGE solution.

Methods according to the present disclosure use sufficient PVA and poly-epoxide cross-linker to arrive at a mole ratio of about 30:1 to about 75:1 (moles of PVA:mole of cross-linker). In preferred examples, the mole ratio is about 45:1 to about 55:1.

The cross-linked PVA polymer may be cast on a backing, such as a polyester sheet.

The cross-linked PVA polymer may be coagulated with a dehydrating solution, such as an aqueous salt solution or an aqueous alkali solution. A sodium sulfate solution, for example, may be used to coagulate the polymer. Alternatively, a sodium chloride or a magnesium sulfate solution may be used.

The aqueous salt solution is preferably, but not necessarily, a saturated solution. At 55° C., the salt solution may be a sodium sulfate solution at a concentration of about 200 g/L to about 450 g/L.

The coagulation is preferably performed at an elevated temperature, such as from about 25° C. to about 90° C. When using sodium sulfate, is particularly preferred to perform the coagulation at a temperature from about 35° C. to about 55° C. This temperature range is preferred since it maintains sodium sulfate at a solubility of at least 400 g/L, while allowing a user to handle the solution with reduced risk. Temperatures greater than 55° C. may be used since the solubility of the sodium sulfate is at least 400 g/L, but are not preferred since there is an increased risk of physical injury.

The cross-linked polymer may be allowed to coagulate in the dehydrating solution for about 15 minutes to about 2 hours before being rinsed. In some examples, the polymer is allowed to coagulate for 30 minutes or less, preferably for about 20 minutes.

Methods discussed above to generate the cross-linked PVA may additionally include steps to add a salt-rejecting polymer layer to a surface of the cross-linked PVA membrane. The salt-rejecting polymer may be added using interfacial polymerization, which covalently attaches the salt-rejecting polymer layer to the surface of the cross-linked PVA membrane, thereby reducing the possibility of delamination. The interfacial polymerization may include reaction of —OH groups on the PVA membrane with a poly acyl chloride, followed by reaction of unreacted acyl chloride groups on the polyacyl chloride with a poly amine compound, and further reaction of the resulting amide with additional poly acyl chloride. The poly acyl chloride may be any poly acyl chloride known to be suitable in general reverse osmosis membrane chemistry, for example: trimesoyl chloride, succinyl chloride, malonyl chloride, or combinations thereof. The poly amine compound may be any polyamine known to be suitable in general reverse osmosis membrane chemistry, for example: m-phenylenediamine, p-phenylenediamine, 2,6-diaminetoluene, 1,4-diaminocyclohexane, methylated MPD, or combinations thereof.

Interfacial polymerization using PVA may be accomplished using conventional methods. An example of interfacial polymerization using a cellulose-based membrane is disclosed by I. Alsvik and M. Hagg in J. Membr. Sci 2013 428 pp 225-213, whose experimental protocol is incorporated herein by reference.

Interfacial polymerization as used in the preparation of reverse osmosis membranes is discussed by J. E. Cadottea, R. S. Kinga, R. J. Majerlea & R. J. Petersena in “Interfacial Synthesis in the Preparation of Reverse Osmosis Membranes” (Journal of Macromolecular Science: Part A—Chemistry, 15:5 (1981), pp 727-755), the teachings of which are incorporated herein by reference.

### EXAMPLES

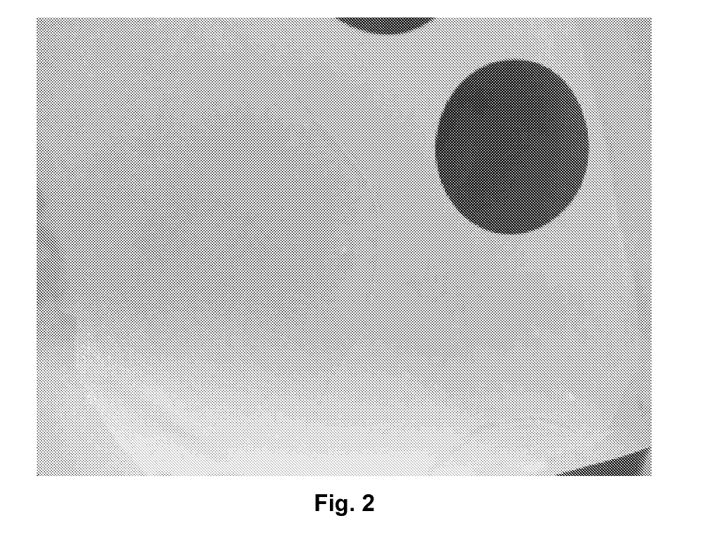

Membrane shown in FIG. 2. A solution of 7% PVA (Sigma Aldrich 36306-5, 99+% hydrolyzed, MW: 146000-186000) was prepared by dissolving 35 g of PVA into 465 g of deionized (DI) water at 80-90° C. for approximately 3 h with the help of a mixer. No degassing was carried out. A solution of 5.5% CHDMDGE was prepared by mixing 2.8 g of CHDMDGE with 48 g of the 7% PVA solution at 50-70° C. for 2-6 hours to get a solution as clear as possible.

A doctor blade with 0.5 mm gap was used to cast the resulting dope onto a polyethylene terephthalate (PET) support properly attached to a glass plate. The casted layer was then cured by immersing the layer in a sodium sulfate solution (400 g sodium sulfate per liter) heated to 55° C.

The casted layer was immersed for a couple of minutes and then removed from the sodium sulfate solution so that the saturated salt solution would cool down below 35° C. and start crystalizing.

The resulting membrane (shown in FIG. 2) was smooth, with no significant spalling, no dope penetrated the PET backing, and white in color. This membrane had a flux with an A-value (pure water permeability coefficient) of 182. After thin film composite coating with 2.75 wt % m-phenyldiamine (MPD) and 0.15 wt % trimesoyl chloride (TMC), there was no flux.

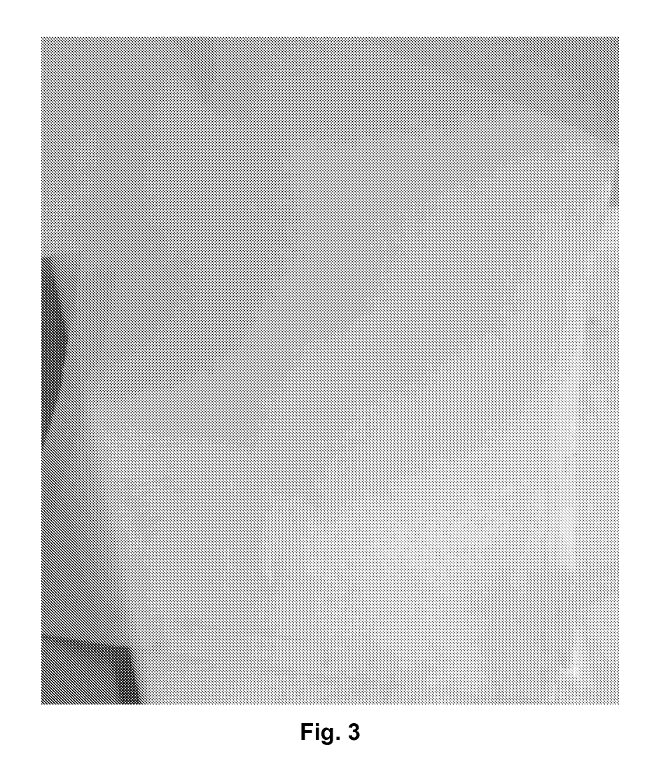

Membrane shown in FIG. 3. The procedure described above for the membrane shown in FIG. 2 was used to prepare the membrane shown in FIG. 3, except that the sodium sulfate solution was maintained at a temperature of 55° C. and the casted layer was immersed in the sodium sulfate solution for 20 minutes. The resulting membrane (shown in FIG. 3) was smooth, with no significant spalling, no dope penetrated the PET backing, and the membrane was less white than the membrane shown in FIG. 2.

Adhesion to the PET support was improved over the membrane shown in FIG. 2. The thickness of the membrane shown in FIG. 3 is about 0.3 mm. The membrane had flux with an A-value of 41, and after thin film composite coating with 2.75 wt % m-phenyldiamine (MPD) and 0.15 wt % trimesoyl chloride (TMC), the coated membrane had a flux with an A-value of 0.3, and salt rejection of 90%.

### COMPARATIVE EXAMPLES

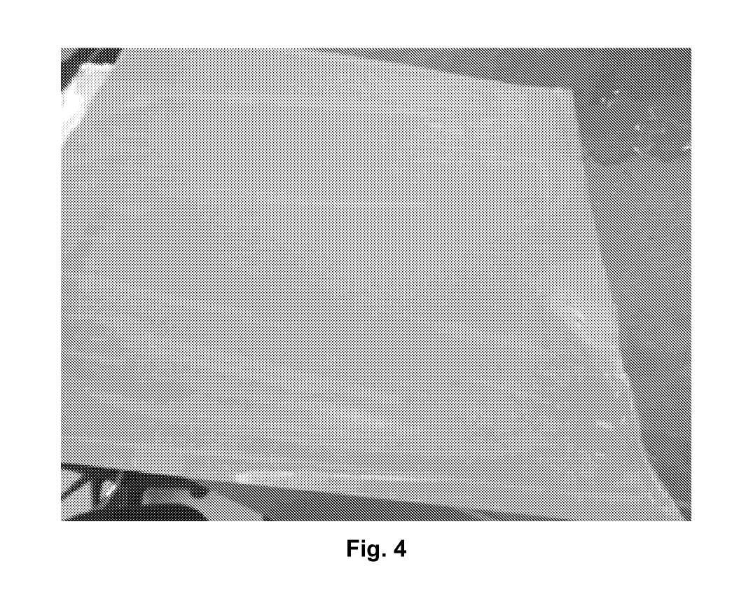

Membrane shown in FIG. 4. A solution of 5% PVA was prepared by dissolving 20 g of PVA into 380 g of DI water at 80-90° C. for about 3 h with the help of a mixer. A solution 4.0% CHDMDGE was prepared by mixing 2 g of CHDMDGE with 48 g of the 5% PVA solution at 50-70° C. for 2-6 hours to get a solution as clear as possible. The dope was degassed using ultrasonic vibration to remove air bubbles if any.

A doctor blade with 1.0 mm gap was used to cast the resulting dope onto a PET support properly attached to a glass plate.

The casted layer was then cured in an oven at a temperature of 85° C. for 1-2 hr.

The resulting membrane (shown in FIG. 3) was translucent, rough, had slight spalling, and the dope penetrated through the backing due to low viscosity. The resulting membrane had no flux.

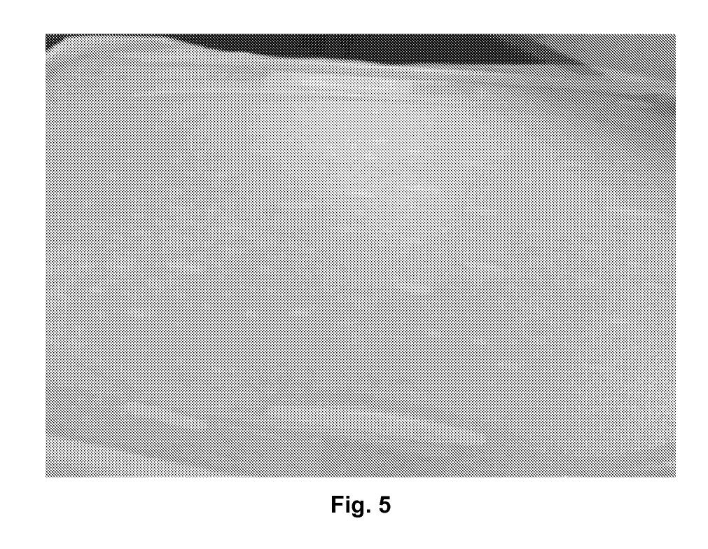

Membrane shown in FIG. 5. The procedure described above for the membrane shown in FIG. 4 was used to prepare the membrane shown in FIG. 5, except that a solution of 10% PVA and a solution of 7.7% CHDMDGE were used, without degassing.

The resulting membrane was translucent, less rough than the membrane shown in FIG. 4, did not have significant spelling, and penetrated much less through the PET backing than did the membrane shown in FIG. 4. It has no flux.

Membrane Testing

The membrane shown in FIG. 2 allowed for free flow of water through the membrane without any applied pressure. The authors of the present disclosure believe that this may be due to damage of the membrane due to crystallization of the sodium sulfate during the curing step.

The membranes shown in FIGS. 3-5 were tested for normalized flux at a pressure of 25 psi using an Amicon stirred cell (model 8200). After coating the membrane with the thin film composite layer, the membrane was flushed with sodium chloride (5232 μS) at a pressure of 200 psi using the high pressure cell test bench. The normalized flux (A-value) and salt rejection were obtained from the permeate.

In the preceding description, for purposes of explanation, numerous details are set forth in order to provide a thorough understanding of the embodiments. However, it will be apparent to one skilled in the art that these specific details are not required. Accordingly, what has been described is merely illustrative of the application of the described embodiments and numerous modifications and variations are possible in light of the above teachings.

Since the above description provides example embodiments, it will be appreciated that modifications and variations can be effected to the particular embodiments by those of skill in the art. Accordingly, the scope of the claims should not be limited by the particular embodiments set forth herein, but should be construed in a manner consistent with the specification as a whole.

1. A method comprising:
crosslinking a dissolved polyvinyl alcohol (PVA) with a dissolved poly-epoxide crosslinker;
casting the cross-linked PVA on a backing to form a membrane; and
coagulating the cast cross-linked PVA membrane using phase immersion precipitation.

2. The method according to claim 1, wherein the crosslinking comprises reacting the PVA with a poly-epoxide crosslinker in a molar ratio of about 30:1 to about 75:1.

3. The method according to claim 1, wherein the dissolved PVA is at a concentration from about 0.1% to about 50% wt/wt.

4. The method according to claim 1, wherein the dissolved poly-epoxide crosslinker is at a concentration from about 0.1% to about 20% wt/wt.

5. The method according to claim 1, wherein the coagulating is for up to about 2 hours, such as about 20 minutes or about 30 minutes, and is followed by a rinsing of the membrane.

6. The method according to claim 1, wherein the coagulating comprises treating the cast cross-linked PVA membrane with a dehydrating solution that is a saturated solution of sodium sulfate at a temperature of from about 35° C. to about 55° C.

7. The method according to claim 1, wherein the dissolved PVA, the dissolved poly-epoxide crosslinker, or both further comprise silica, and wherein the method further comprises treating the resulting coagulated cross-linked PVA membrane with sufficient sodium hydroxide and for a sufficient length of time to remove the silica and reveal pores in the membrane.

8. The method according to claim 1, further comprising forming an interfacial polymerization layer on a surface of the cross-linked PVA membrane.

9. The method according to claim 8, wherein forming an interfacial polymerization layer comprises reacting a poly-acid chloride with at least a portion of the —OH groups on the surface of the cross-linked PVA membrane; reacting polyamine with at least a portion of the unreacted acyl chloride groups of the poly-acid chloride bound to the membrane; and reacting poly-acid chloride with at least a portion of the unreacted amine groups of the polyamine bound to the membrane.

10. The method according to claim 9, wherein the poly-acid chloride is trimesoyl chloride, and the polyamine is m-phenylenediamine.

11. A membrane comprising cross-linked polyvinyl alcohol (PVA) polymers, wherein the PVA polymers are bound to the cross-linker though polyether bonds.

12. The membrane according to claim 11, wherein the cross-linker is the reaction product of a poly-epoxide and —OH groups of the PVA polymers.

13. The membrane according to claim 12, wherein the poly-epoxide is cyclohexanedimethanol diglycidyl ether (CHDMDGE).

14. The membrane according to claim 11, wherein the PVA polymers and the cross-linker are in a molar ratio of from about 30:1 to about 75:1 (moles of PVA:mole of cross-linker).

15. The membrane according to claim 11, wherein the PVA polymers have a degree of hydrolysis from about 50% to about 100%.

16. The membrane according to claim 11, wherein the thickness of the membrane is from about 2 mils to about 10 mils.

17. The membrane according to claim 11, wherein the membrane comprises pores sized to have a molecular weight cutoff for sugar of about 500 g/mol to about 10,000 g/mol.

18. The membrane according to claim 11, further comprising a salt-rejecting polymer layer covalently bonded to —OH groups on a surface of the membrane.

19. The membrane according to claim 18, wherein the —OH groups are covalently bonded through ester functional groups to poly-acyl compounds, at least a portion of the acyl functional groups on the poly-acyl compounds are bonded through amide groups to poly-amine compounds, and at least a portion of the amine functional groups on the poly-amine compounds are bonded through amide groups to additional poly-acyl compounds.

20. The membrane according to claim 19 wherein the poly-acyl compounds are tri-mesoyl chloride, and the poly-amine compounds are m-phenylenediamine.

21. The membrane according to claim 17, wherein the membrane is a reverse osmosis membrane.
